(19) United States
(12) Patent Application Publication
(10) Pub. No.: US 2025/0206210 A1
(43) Pub. Date: Jun. 26, 2025

(54) TRIM COVER ASSEMBLY

(71) Applicant: Lear Corporation, Southfield, MI (US)

(72) Inventors: Michelle A. BRUDZYNSKY, Farmington Hills, MI (US); Joshua HALLOCK, Warren, MI (US); Lisa SWIKOSKI, West Bloomfield, MI (US)

(21) Appl. No.: 18/390,184

(22) Filed: Dec. 20, 2023

(51) Int. Cl. B60N 2/58

(52) U.S. Cl. CPC B60N 2/5825

(57) ABSTRACT

An assembly is provided with a first layer sized to be displaced over a seat component. A tie down is connected to the first layer to extend at least partially along or at least partially through a cushion of the seat component. A retainer is connected to the tie down, and is sized to retain the tie down and the first layer to the seat component. A second layer is stacked upon and secured to the first layer. A third layer is stacked upon and secured to the second layer.

### TECHNICAL FIELD

Various aspects relate to seat assemblies and multi-layer trim covers, and methods for manufacturing seat assemblies and multi-layer trim covers.

### BRIEF DESCRIPTION OF THE DRAWINGS

FIG. 1 is a front perspective view of a seat assembly in accordance with an embodiment;

FIG. 2 is a partial section view of a trim assembly of the seat assembly of FIG. 1, in accordance with an embodiment; and

FIG. 3 is a perspective view of a trim clip of a seat assembly according to an embodiment.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first layer could be termed a second layer, and, similarly, a second layer could be termed a first layer, without departing from the scope of the various described embodiments. The first layer and the second layer are both layers, but they are not the same layer.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including.” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

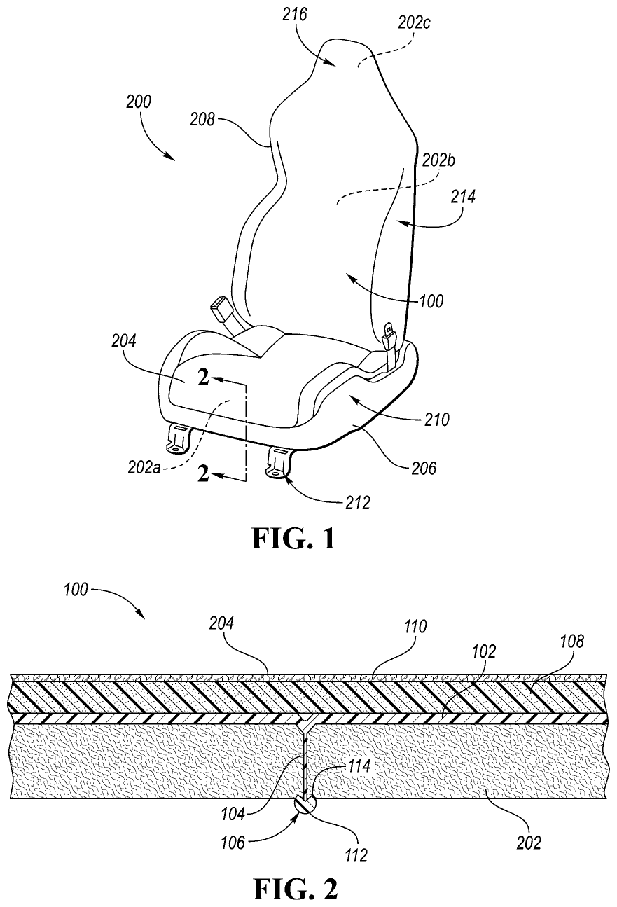

FIG. 1 illustrates a seat assembly 200 according to some embodiments. The seat assembly 200 is depicted as a vehicle seat assembly 200. According to some embodiments, the seat assembly 200 is for a land vehicle, watercraft, aircraft, or the like. The seat assembly 200 may be employed in a passenger vehicle, a straddle-type vehicle, or the like. The seat assembly 200 may be an office chair, a comfort chair, or the like.

The seat assembly 200 includes a seat bottom 210 sized to receive and support a pelvic region and thighs of an occupant. In some embodiments, a plurality of supports, rails, or brackets 212 may be connected to the seat bottom 210 to support the seat bottom 210 upon an underlying support surface. In some vehicle embodiments, the brackets 212 are adapted to be mounted to a vehicle floor. A seat back 214 extends upright from the seat bottom 210. The seat back 214 is sized to receive and support pelvic, lumbar, thoracic and shoulder regions of the occupant. A head restraint 216 is also provided upon the seat back 214 to receive and support a head of a seated occupant.

The seat bottom 210, the seat back 214, and the head restraint 216 each include a cushion 202a, 202b, 202c (“202”). Each of these cushions 202a, 202b, 202c, may be formed separately, or integrally with an adjacent cushion 202a, 202b, 202c.

FIG. 1 shows an assembly 100 as a trim cover assembly 100 according to some embodiments. The trim cover assembly 100 is sized to be fitted over the seat assembly 200 to receive and conceal the underlying components, including the cushions 202a, 202b, 202c. Conventional trim cover assemblies attach to the cushions or a frame of the seat assembly along a seam or seams of the convention trim cover assembly. The trim cover assembly 100 attaches to the cushions 202a, 202b, 202c at any location with or without a seam.

The trim cover assembly 100 is illustrated in greater detail in FIG. 2. The trim cover assembly 100 may include a first layer 102. The first layer 102 may be sized to be displaced over a seat component of the seat assembly 200. The first layer 102 may be a base layer 102 that contacts the cushion 202 directly. The first layer 102 may include a non-woven material. For example, the first layer 102 may be provided with polypropylene fibers. The first layer 102 may be formed from olefin fibers. The first layer 102 may be, for instance, a non-woven fabric of manmade or natural fibers, known as DUON®, which is a registered trademark of Propex Operating Company, LLC, a Delaware Company at 4019 Industry Drive, Chattanooga Tennessee 37416. Alternatively, the first layer 102 may include a non-woven material with similar physical properties as a DUON® material.

According to some embodiments, a tie down 104 is attached to the first layer 102. The tie down 104 may be connected to the first layer 102 to extend at least partially along or at least partially through the cushion 202 of the seat component 200. The tie downs 104 may be provided from the same material as the first layer 102. Alternatively, the tie downs 104 may be provided from a material that is different from the material of the first layer 102. The tie downs 104 are a tether that may extend from a point, or along a length. The tie downs 104 may include a material having one or more of the following properties: anti-odor, anti-static, dust resistance, or stain resistance.

According to some embodiments, the tie down 104 includes a retainer 106. The retainers 106 may include a material that is different from the material of the first layer 102. The retainers 106 may also include a material that is different from the material of the tie downs 104. The retainers 106 may be formed separately from the tie downs 104 and subsequently attached to the tie downs 104. The retainers 106 each have a leading edge 112 for insertion into another retainer. The retainers 106 each have an abutment edge 114 for retained engagement into the other retainer.

The tie down 104 may be sized to retain the tie down 104 and the first layer 102 to the seat component 200. It is recognized that the first layer 102 may include one or more tie downs 104, each tie down 104 having a retainer 106. The assembly 100 may further include a second layer 108 stacked upon the first layer 102. The second layer 108 may be secured to the first layer 102. The second layer 108 may include a foam material. The second layer 108 may include a polyester foam material. The second layer 108 may alternatively include a foam-free polyester material or other foam-free material. The second layer 108 may include a non-woven fleece material.

The assembly 100 may additionally include a third layer 110 stacked upon the second layer 108. The third layer 110 may be secured to the second layer 108. The third layer 110 may include a trim cover. The trim cover may include a textile material. For example, the trim cover may include warp knit, woven, double-needle bar, or bi-laminate textiles. The trim cover may alternatively include a leather material.

The third layer 110 may be secured to the second layer 108 via lamination. The second layer 108 may be secured to the first layer 102 via a lamination process that is free of adhesives. For instance, the first layer 102 and the second layer 108 may be secured together using thermal lamination or thermal bonding. The first layer 102 and the second layer 108 may be secured together using thermal area bonding or thermal point bonding for example. By securing the first layer 102 to the second layer 108 using heat, the assembly 100 remains free of non-recyclable adhesives. The assembly 100 and the seat component 200 over which the assembly is displaced may be more easily recycled. Additionally, using thermal lamination to secure the first layer 102 to the second layer 108 may give the trim cover 110 a smooth appearance without visible deformation on an external or A-surface 204 of the cushion 202 of the seat component 200. Likewise, tensile loading of the tie down 104 is distributed to the first layer 102 to avoid visible deformation on the external surface 204 of the trim cover 110. The second layer 108 provides a buffer between the first layer 102 and the trim cover 110 to dissipate any tensile loading from deforming the trim cover 110. By avoiding visible deformation to the trim cover 110, the tie down 104 may be provided anywhere along the trim cover assembly 100, and is not limited to seams. The tie downs 104 may also be provided within concave regions of the trim cover assembly 100.

The trim cover assembly 100 may further include the cushion 202. The one or more tie downs 104 of the first layer 102 may secure the secured layers to the cushion 202. The secured layers, all three of which may be sized to be displaced over a seat component 200, may be disposed on the A surface 204 of the cushion 202 with the bottom side of the first layer 102 in physical contact with the A surface 204 of the cushion 202, and the top side of the third layer 110 facing away from the A surface 204 of the cushion 202. The bottom side of the first layer 102 may be the side opposite the second layer 108, and the top side of the third layer 110 may be the side opposite the second layer 108. The one or more tie downs 104 may extend from the first layer 102 partially around or through the cushion 202 away from the A surface 204 and toward the B surface 206 of the cushion 202. The retainers 106 on the one or more tie downs 104 may secure the secured layers and the one or more tie downs 104 underneath or adjacent to a concealed or B surface 206 of the cushion 202. The retainers 106 may secure the secured layers 102, 108, 110, and the one or more tie downs 104 to a frame 208 of the seat component 200. The tie downs 104 and retainers 106 may secure the secured layers 102, 108, 110, to the cushion 202 without visible deformation on the A-surface 204 of the cushion 202.

Any of the first layer 102, second layer 108, or third layer 110 may include a material having one or more of the following properties: anti-odor, anti-static, dust resistance, or stain resistance. Any of the first layer 102, second layer 108, or third layer 110 may also include materials that may be recycled or may include recycled materials, or both.

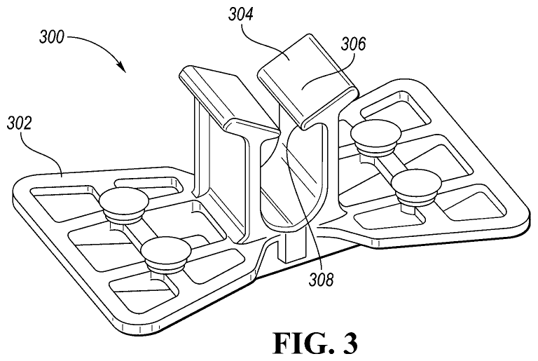

FIG. 3 illustrates a trim clip 300 according to an embodiment. The trim clip 300 may function as is known in the art, with a base 302 that is sized to be received in a trench within one of the cushions 202. The base 302 retains the clip 300 against an underside of the cushion 202. Alternatively, the base 302 is fastened to the frame 208 of the seat assembly 200. The trim clip 300 also includes a pair of retainers 304 extending from the base 302. The trim clip retainers 304 receive the retainer 106 of the tie down 104. During installation, the leading edge 112 of the tie down retainer 106 engages leading edges 306 of the trim clip retainers 304. Upon further translation of the tie down retainer 106 into the trim clip retainers 304, the trim clip retainers 304 expand and permit the tie down retainer 106 in between the retainers 304. Once installed, the abutment edges 114 of the tie down retainer 106 engage abutment edges 308 of the trim clip 300 to secure the tie down retainer 106, and consequently the tie down 104, and the trim cover assembly 100, to the trim clip 300 with the cushion 202 therebetween. Multiple trim clips 300 may be employed, and may be interconnected, or tethered in arrays or strips known as ganged clips 300. The trim clips 300 may also be formed from a similar recyclable material, polyester.

In additional embodiments, an apparatus 100 is provided with a trim cover 110, a backing 108, and an attachment layer 102 is provided. The trim cover 110 may be stacked upon and secured to the backing 108. The backing layer 108 may be stacked upon and secured to the attachment layer 102. The backing layer 108 and the attachment layers 102 may be secured via adhesive-free lamination. The attachment layer 102 may include at least one tie down 104 attached to the attachment layer 102. Each of the at least one tie downs 104 may include a retainer 106. The retainers 106 may secure the apparatus 100 over a seat component 200. The seat component 200 may include a cushion 202. The apparatus 100 may be displaced over the A-surface 204 of the cushion 202. The tie downs 104 and retainers 106 may secure the apparatus 100 partially around or through the cushion 202. The retainers may secure the apparatus underneath or adjacent to the B-surface 206 of the cushion 202. The retainers may alternatively secure the apparatus to the B-surface 206 of the cushion 202. Securing the attachment layer 102 with the tie downs 104 and the retainers 106 to the backing layer 108 via thermal lamination, for example, minimizes visible deformation to the trim cover 110 when the tie downs 104 are under tension. The apparatus 100 may also be mounted over the cushion 202 of a seat assembly 200 including a frame 208, a cushion 202 supported by a frame 208, and a second retainer 300.

In other embodiments, a method for forming a three-layer trim cover assembly 100 with tie-downs 104 without visible deformation on the A-surface 204 of a cushion 202 is provided. The three-layer trim system may mimic bonded trim without the use of non-recyclable adhesives. The method may include attaching at least one tie down 104 to a first layer 102; attaching a retainer 106 to the at least one tie down 104; stacking a second layer 108 upon the first layer 102; securing the second layer 108 to the first layer 102; stacking a seat trim cover 110 upon the second layer 108; and securing the seat trim cover 110 to the second layer 108 to form a multi-layer trim cover assembly 100. The method may further include securing the second layer 108 to the first layer 102 through a lamination process that is free of adhesives. For example, the method may include securing the second layer 108 to the first layer 102 via thermal lamination. Such a process may eliminate the need for an adhesive layer that may include non-recyclable materials or the need for additional tooling to connect the trim cover assembly layers. The method may further include securing the trim cover assembly 100 to a seat cushion assembly 200 in a vehicle.

A first clause, which may or may not be combined with any of the following clauses, is provided with an assembly with a first layer sized to be displaced over a seat component. A tie down is connected to the first layer to extend at least partially along or at least partially through a cushion of the seat component. A retainer is connected to the tie down, and is sized to retain the tie down and the first layer to the seat component. A second layer is stacked upon and secured to the first layer. A third layer is stacked upon and secured to the second layer.

A second clause, which may be combined with any of the preceding or following clauses, provides the assembly with a cushion wherein the at least one tie down and the retainer secure the secured layers to the cushion.

A third clause, which may be combined with any of the preceding or following clauses, provides the assembly wherein the first layer comprises a non-woven material.

A fourth clause, which may be combined with any of the preceding or following clauses, provides the assembly wherein the first layer comprises DUON®.

A fifth clause, which may be combined with any of the preceding or following clauses, provides the assembly wherein the second layer comprises a foam material.

A sixth clause, which may be combined with any of the preceding or following clauses, provides the assembly wherein the second layer comprises a non-woven fleece material.

A seventh clause, which may be combined with any of the preceding or following clauses, provides the assembly wherein the third layer comprises a trim cover.

An eighth clause, which may be combined with any of the preceding or following clauses, provides the assembly wherein the third layer comprises a textile or leather material.

A ninth clause, which may be combined with any of the preceding or following clauses, provides the assembly wherein the second layer is laminated to the first layer.

A tenth clause, which may be combined with any of the preceding or following clauses, provides an apparatus providing a trim cover, a backing stacked upon and secured to the trim cover, an attachment layer stacked upon and secured to the backing, at least one tie down attached to the attachment layer, and a retainer connected to the at least one tie down. The backing minimizes visible deformation to the trim cover when the at least one tie down is under tension.

An eleventh clause, which may be combined with any of the preceding or following clauses, provides the apparatus wherein the backing comprises a different material than the material of the trim cover.

A twelfth clause, which may be combined with any of the preceding or following clauses, provides the apparatus wherein the trim cover comprises a different material than the attachment layer.

A thirteenth clause, which may be combined with any of the preceding or following clauses, provides the apparatus wherein the backing is secured to the attachment layer using heat.

A fourteenth clause provides a seat assembly with a frame, a cushion supported by the frame, a second retainer, and the apparatus of any of the preceding or following clauses. The apparatus is mounted over the cushion.

A fifteenth clause, which may be combined with any of the preceding or following clauses, provides the apparatus wherein the retainer comprises a different material than the material of the attachment layer.

A sixteenth clause, which may be combined with any of the preceding or following clauses, provides a method of attaching at least one tie down to a first layer, attaching a retainer to the at least one tie down, stacking a second layer upon the first layer, securing the second layer to the first layer, stacking a seat trim cover upon the second layer, and securing the seat trim cover to the second layer to form a multi-layer trim cover assembly.

A seventeenth clause, which may be combined with any of the preceding or following clauses, provides the method wherein the first layer comprises a non-woven material.

An eighteenth clause, which may be combined with any of the preceding or following clauses, provides the method wherein the second layer comprises a foam material.

A nineteenth clause, which may be combined with any off the preceding or following clauses, provides the method wherein the second layer comprises a non-woven fleece material.

A twentieth clause, which may be combined with any of the preceding or following clauses, provides the method wherein the third layer comprises a different material than the material of the first layer.

A twenty-first clause, which may be combined with any of the preceding or following clauses, provides the method with laminating the second layer to the first layer.

A twenty-second clause, which may be combined with any of the preceding or following clauses, provides the method with securing the trim cover assembly to a seat cushion assembly in a vehicle.

While various embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

1. An assembly comprising:
a first layer sized to be displaced over a seat component;
a tie down connected to the first layer to extend at least partially along or at least partially through a cushion of the seat component;
a retainer connected to the tie down, sized to retain the tie down and the first layer to the seat component;
a second layer stacked upon and secured to the first layer; and
a third layer stacked upon and secured to the second layer.

2. The assembly of claim 1, further comprising a cushion wherein the at least one tie down and the retainer secure the secured layers to the cushion.

3. The assembly of claim 1, wherein the first layer comprises a non-woven material.

4. The assembly of claim 3, wherein the first layer comprises DUON®.

5. The assembly of claim 1, wherein the second layer comprises a foam material.

6. The assembly of claim 1, wherein the second layer comprises a non-woven fleece material.

7. The assembly of claim 1, wherein the third layer comprises a trim cover.

8. The assembly of claim 6, wherein the third layer comprises a textile or leather material.

9. The assembly of claim 1, wherein the second layer is laminated to the first layer.

10. An apparatus comprising:
a trim cover;
a backing stacked upon and secured to the trim cover;
an attachment layer stacked upon and secured to the backing;
at least one tie down attached to the attachment layer; and
a retainer connected to the at least one tie down, wherein the backing minimizes visible deformation to the trim cover when the at least one tie down is under tension.

11. The apparatus of claim 10, wherein the backing comprises a different material than the material of the trim cover.

12. The apparatus of claim 10, wherein the trim cover comprises a different material than the attachment layer.

13. The apparatus of claim 10, wherein the backing is secured to the attachment layer using heat.

14. A seat assembly comprising:
a frame;
a cushion supported by the frame;
a second retainer; and
the apparatus of claim 10, wherein the apparatus is mounted over the cushion.

15. The apparatus of claim 10, wherein the retainer comprises a different material than the material of the attachment layer.

16. A method comprising:
attaching at least one tie down to a first layer;
attaching a retainer to the at least one tie down;
stacking a second layer upon the first layer;
securing the second layer to the first layer;
stacking a seat trim cover upon the second layer; and
securing the seat trim cover to the second layer to form a multi-layer trim cover assembly.

17. The method of claim 16, wherein the first layer comprises a non-woven material.

18. The method of claim 16, wherein the second layer comprises a foam material.

19. The method of claim 16, wherein the second layer comprises a non-woven fleece material.

20. The method of claim 16, wherein the third layer comprises a different material than the material of the first layer.

21-22. (canceled)
